(19) United States
(12) Patent Application Publication
(10) Pub. No.: US 2023/0318068 A1
(43) Pub. Date: Oct. 5, 2023

(54) SYSTEMS CONFIGURED FOR THERMAL MANAGEMENT OF BATTERY CELLS

(71) Applicant: STANDARD ENERGY INC., Daejeon (KR)

(72) Inventors: Dongyoung Lee, Daejeon (KR); Bugi Kim, Daejeon (KR)

(21) Appl. No.: 18/181,783

(22) Filed: Mar. 10, 2023

(30) Foreign Application Priority Data
Mar. 31, 2022 (KR) 10-2022-0040808

(51) Int. Cl. H01M 10/615; H01M 10/6552; H01M 10/6566; H01M 10/42

(52) U.S. Cl. CPC H01M 10/615; H01M 10/6552; H01M 10/6566; H01M 10/425; H01M 2010/4271

(57) ABSTRACT

The disclosed technology relates generally to battery management systems and more particularly to battery management systems configured for thermal management of battery cells. In one aspect, a battery system comprises a plurality of battery cells electrically connected to each other. The battery system comprises a plurality of switches each connected to one of the battery cells. The battery system additionally comprises one or more heaters electrically connected to the switches and configured to generate heat upon activation of one or more switches by dissipating power from the battery cells. The battery system further comprises one or more heat conduits configured to channel the heat generated by the one or more heaters towards at least one of the battery cells.

### CROSS-REFERENCE TO RELATED APPLICATIONS

This application claims priority to Korean Patent Application No. 10-2022-0040808, filed on Mar. 31, 2022, the disclosure of which including the specification, the drawings, and the claims is hereby incorporated by reference in its entirety.

### BACKGROUND

### Field

The disclosed technology relates generally to battery management systems and more particularly to battery management systems configured for thermal management of battery cells.

### Description of the Related Art

The global economic growth accompanied by global warming continues increase the urgency of a need for renewable and sustainable energy systems based on renewable energy, e.g., solar and wind energy. To enhance the stability of grid networks against fluctuations due to intermittent availability such forms of energy, advances in energy storage systems (ESS) are used for storing surplus electricity, which can be delivered to end customers or to power grids when needed. Among others, ESS based on electrochemical energy, e.g., rechargeable or secondary batteries, can provide cost effective and clean forms of energy storage solutions. Examples of electrochemical energy storage systems include lithium-ion, lead-acid, sodium-sulfur and redox-flow batteries. Different storage times are needed for different applications: short-term storage, medium-term storage and long-term storage. The different types of electrochemical energy storage systems have different physical and/or chemical properties. Factors that determine the suitability for a particular application of the electrochemical energy storage systems include investment cost, power, energy, lifetime, recyclability, efficiency, scalability and maintenance cost, to name a few. Competing factors are weighed in the selection and design of a suitable electrochemical energy storage system.

### SUMMARY

In a first aspect, a battery system comprises a plurality of battery cells electrically connected to each other. The battery system additionally comprises a plurality of switches each connected to one of the battery cells. The battery system additionally comprises one or more heaters electrically connected to the switches and configured to generate heat upon activation of one or more switches by dissipating power from the battery cells. The battery system further comprises one or more heat conduits configured to channel the heat generated by the one or more heaters towards at least one of the battery cells.

In a second aspect, a battery system comprises a plurality of battery cells electrically connected to each other. The battery system additionally comprises a plurality of switches each connected to one of the battery cells. The battery system additionally comprises one or more heaters electrically connected to the switches and configured to generate heat upon activation of one or more switches by dissipating power from the battery cells. The one or more heaters are configured to serve as one or more resistors for actively or passively balancing states of charge (SoC) of the battery cells and to cause a temperature of the battery cells to rise from the heat.

In a third aspect, a thermal management method for a battery system comprises detecting a state of charge (SoC) of each of a plurality of battery cells electrically connected to each other. The method additionally comprises dissipating power from one or more battery cells having an SoC above a predetermined threshold value through one or more heaters to generate heat by activating one or more switches connected to the battery cells. The method further comprises channeling the heat generated from the one or more heaters through one or more heat conduits towards at least one of the battery cells. The battery system can be in accordance with one or both of the first and second aspects.

In a fourth aspect, an energy storage system (ESS) comprises a battery system comprising a plurality of battery cells electrically connected to each other, a plurality of switches each connected to one of the battery cells, and one or more resistors electrically connected to the switches for actively or passively balancing states of charge (SoC) of the battery cells. The ESS additionally comprises a power control system (PCS) electrically connected to the battery system. The ESS additionally comprises an electric load electrically connected to the PCS. One or both of the PCS and the electric load are configured to be electrically connected to a grid. In addition, one or more of the battery system, the PCS and the electric load are thermally insulated from each other by a thermal insulator. The battery system can be in accordance with one or both of the first and second aspects.

In a fifth aspect, an energy storage system (ESS) comprises a battery system comprising a plurality of battery cells electrically connected to each other, a plurality of switches each connected to one of the battery cells, and one or more resistors electrically connected to the switches for actively or passively balancing states of charge (SoC) of the battery cells. The ESS additionally comprises a power control system (PCS) electrically connected to the battery system. The ESS additionally comprises an electric load electrically connected to the power control unit. One or both of the PCS and the electric load are thermally connected to the battery system by one or more heat conduits configured to channel heat generated by the one or both of the PCS and the electric load towards the at least one of the battery cells. The battery system can be in accordance with one or both of the first and second aspects.

### BRIEF DESCRIPTION OF THE DRAWINGS

FIG. 1A schematically illustrates example states of charge of unmanaged battery cells.

FIG. 1B schematically illustrates example states of charge of managed battery cells.

FIG. 2A schematically illustrates an example of a scheme of active balancing of battery cells.

FIG. 2B schematically illustrates an example of a scheme of passive balancing of battery cells.

FIG. 3A schematically illustrates an example battery system including a plurality of battery cells electrically connected to a battery management system.

FIG. 3B illustrates an example battery system implemented on a common substrate.

FIG. 4A schematically illustrates an example energy storage system configured for a battery system according to embodiments.

FIG. 4B schematically illustrates another example energy storage system configured for a battery management system according to embodiments.

FIGS. 5A-5E schematically illustrate example battery systems configured for thermal management of battery cells, according to various embodiments.

FIG. 6A is a flow chart illustrating a thermal management method for a battery system, according to embodiments.

FIG. 6B is a flow chart illustrating a thermal management method for a battery system, according to embodiments.

FIG. 7A schematically illustrates an energy storage system configured for thermal management of battery cells, according to various embodiments.

FIG. 7B schematically illustrates a battery system configured for thermal management of battery cells, according to some embodiments,

FIG. 7C schematically illustrates a battery system configured for thermal management of battery cells, according to some other embodiments,

FIG. 7D schematically illustrates an energy storage system configured for thermal management of battery cells, according to various embodiments.

FIGS. 8A-8D schematically illustrate redox battery cells that can be implemented as part of a battery and energy storage systems according to embodiments.

### DETAILED DESCRIPTION

The foregoing and other objectives and advantages will appear from the description herein. In the description reference is made to the accompanying drawing, which forms a part hereof, and in which is shown by way of illustration specific embodiments. These embodiments will be described in sufficient detail to enable those skilled in the art to practice the embodiments, and it is to be understood that other embodiment may be utilized and that structural changes may be made without departing from the scope of the disclosed embodiments. The accompanying drawing, therefore, is submitted merely as showing examples of the disclosed embodiments. Accordingly, the following detailed description is not to be taken in a limiting sense, and the scope of the present disclosed embodiments is defined by the appended claims

In view of the above mentioned situation, one of objectives of one or more aspects of some embodiments is to provide a thermal management method and a battery management system which enhance efficiency of the electrochemical energy storage. The battery management system (BMS) refers to a control system electrically coupled to a battery pack including a plurality of battery cells to provide oversight thereto, including monitoring the battery, providing battery protection, estimating the battery's operational state, continually optimizing battery performance and communicating operational status to external devices.

In some embodiments, a battery system includes a battery pack and a battery management system (BMS) coupled hereto. Functions of a BMS include balancing multiple battery cells, which may be electrically connected in series and/or parallel within a battery pack, such that the battery cells within a battery pack attain a similar or substantially the same state of charge (SoC).

In recognition that chemical reactions are accelerated at elevated temperatures, and in further recognition that battery management systems can generate heat during operation, in some other embodiments, the heat generated by the battery management system is harvested and efficiently channeled to battery cells to raise a temperature thereof.

In recognition that chemical reactions are accelerated at elevated temperatures, and in further recognition that battery management systems can generate heat during operation, disclosed herein are embodiments in which the heat generated by battery management systems is harvested and efficiently channeled to battery cells to raise a temperature thereof.

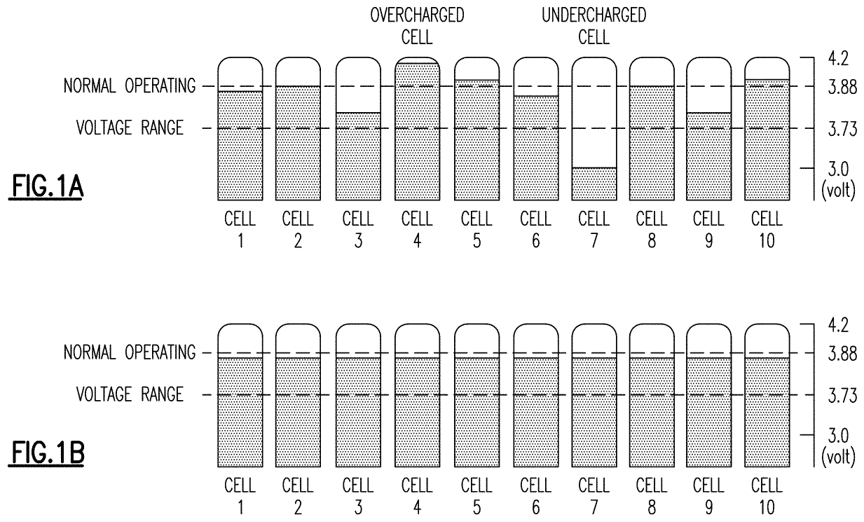

FIGS. 1A and 1B schematically illustrate example states of charge of unmanaged and managed battery cells, respectively. Without a BMS, damage to a degraded battery cell can be accelerated through various processes. For example, during charging, the charging limit of degraded battery cells may be reached prematurely due to reduced capacity thereof. Despite the degraded battery cells having reached their charging limit, the battery pack as a whole may continue to charge. The excess charging may further damage the already degraded battery cells due to overcharging thereof, thereby accelerating the failure of the battery pack. Analogously, during discharging, degraded battery cells may prematurely reach their discharge limit due to their small capacity. Despite the degraded battery cells having reached their discharging limit, the battery pack as a whole may continue to discharge. This excess discharging may further damage the already degraded battery cells due to over-discharging thereof. Thus, there is a need for a BMS to balance the battery cells.

Some balancing schemes can be dissipative in which energy is removed from the most charged cell and is lost as heat. Some other balancing schemes can be nondissipative, in which energy is transferred between different cells and therefore energy lost as heat can be substantially reduced. Dissipative balancing schemes may also be referred to passive balancing schemes, and nondissipative balancing may also be referred to as active balancing schemes.

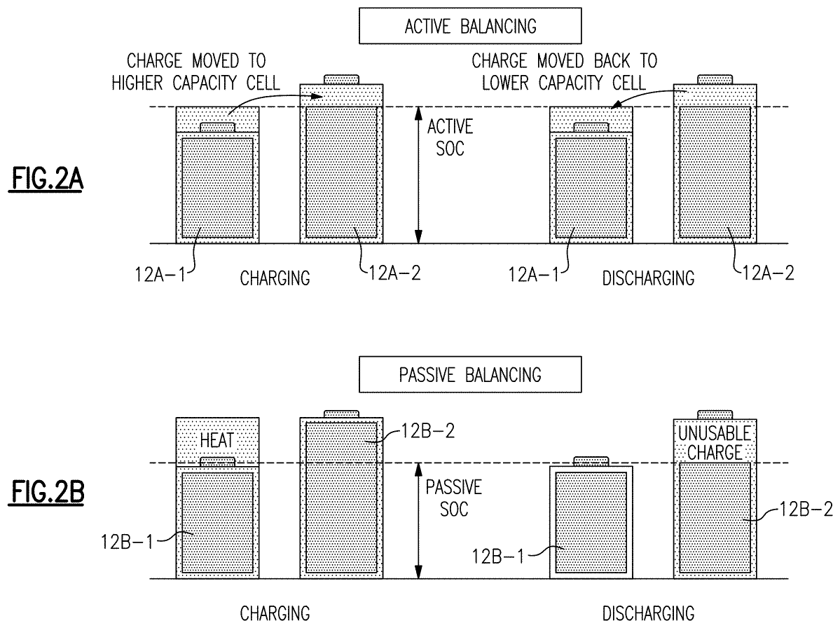

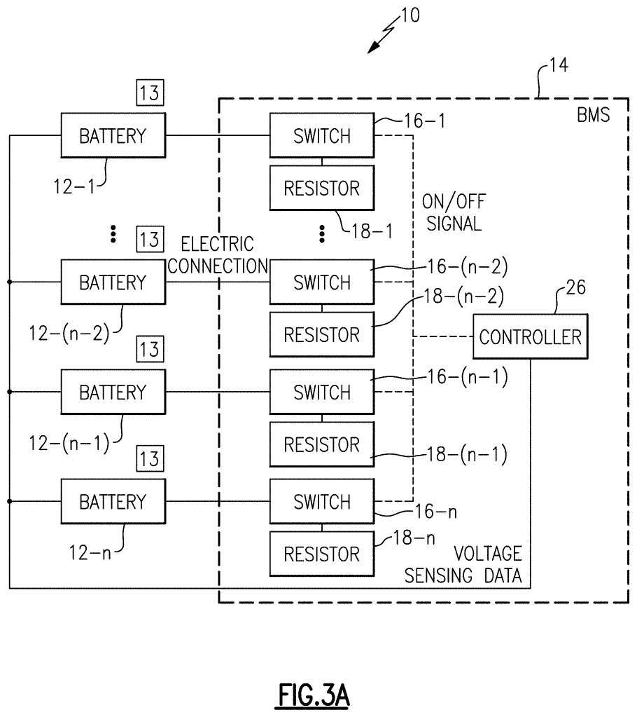

FIGS. 2A and 2B schematically illustrate example methods of active and passive balancing schemes for battery cells, respectively. For illustrative purposes only, FIG. 2A illustrates active balancing between two battery cells 12A-1, 12A-2. Similarly, FIG. 2B illustrates passive balancing between two battery cells 12B-1, 12B-2. With passive and active cell balancing, battery cells in the battery stack are monitored to maintain a healthy battery state of charge (SoC). This extends the battery cycle life and provides preventive protection against damage to the battery cells that may result from over charging and/or over-discharging, as described above. Referring to FIG. 2B, passive balancing results in the battery cells 12B-1, 12B-2 having a similar or substantially the same SoC by simply dissipating excess charge through a bleed resistor; it does not however, extend system run time. Referring to FIG. 2A, active cell balancing is a more complex balancing technique that redistributes charge between the battery cells 12A-1, 12A-2 during the charge and discharge cycles, thereby increasing system run time by increasing the total useable charge in the battery pack, decreasing charge time compared with passive balancing, and decreasing heat generated while balancing.

Passive balancing has some apparent disadvantages. For example, wasting energy may be environmentally detrimental. In addition, heat generated at high balancing currents may detrimentally affect the battery cells. On the other hand, passive balancing has the advantage of being simple and low in cost. While active balancing has apparent advantages because it doesn't waste as much energy, it can also have disadvantages. For example, because more electrical components are used, active balancing may be disadvantageous due to higher cost, lower reliability and/or greater occupied volume. Further, stand-by current generated in active balancing may result in significant and even greater power loss than passive balancing.

Some battery cells lose their capacity at low temperatures because of relatively slower chemical reaction rates governing charging and discharging. For example, charging lithium-ion battery cells below about 0° C. (32° F.) can be problematic because plating of metallic lithium can occur on the anode during sub-freezing charging. The plating can cause permanent damage to the battery cells and not only results in reduced capacity, but the battery cells can also be more vulnerable to failure if subjected to vibration or other stressful conditions. On the other hand, performance loss can occur in lithium-ion battery cells when operated significantly above room temperature (e.g., greater than about 30° C.). If lithium ion battery cells are continuously charged and recharged above this temperature, performance loss can rise be substantial (e.g., as much as 50%). Battery life can also suffer from premature aging and degradation if continually exposed to excessive heat particularly during fast charging and discharging cycles. For these reasons, there is a need for a BMS that can control the temperature of the battery pack, e.g., through heating and cooling of the battery cells.

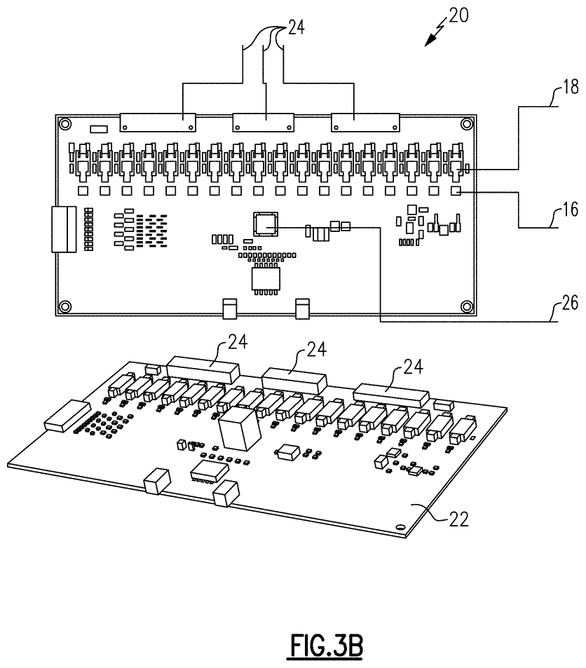

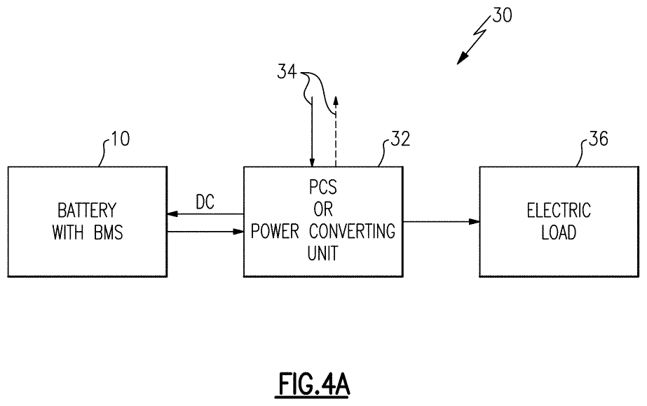

FIG. 3A schematically illustrates an example battery system 10 including a plurality of battery cells 12-1, . . . , 12-(n−2), 12-(n−1), 12-n electrically connected to a battery management system (BMS) 14. The BMS 14 can serve as a base BMS in which various thermal management features and methods described herein can be implemented, according to embodiments. The illustrated BMS 14 may be a passive or an active BMS 14. The plurality of battery cells 12-1, . . . , 12-(n−2), 12-(n−1), 12-n (collectively referred to herein as battery cells 12) are electrically connected to each other, in electrical series and/or parallel. The battery system 10 additionally comprises a plurality of switches 16-1, . . . , 16-(n−2), 16-(n−1), 16-n (collectively referred to herein as switches 16) each connected to corresponding ones of the battery cells 12. The battery system 10 additionally comprises one or more resistors 18-1, . . . , 18-(n−2), 18-(n−1), 18-n (collectively referred to herein as resistors 18) electrically connected to the switches 16 and configured to dissipate power from the battery cells upon activation of one or more switches 16. The battery system 10 further comprises a controller 26 configured to sense a state of charge (SoC) of the battery cells 12 and to selectively activate one or more switches 16 based on the SoC. For example, when the controller senses that a SoC of one or more of the battery cells 12 is above a threshold value after charging for a predetermined period by, e.g., measuring voltages thereof, the controller 26 can activate respective ones of the switches 16 connected to the one or more battery cells 12 to selectively dissipate excess charge therefrom, using respective ones of the resistors 18 connected thereto. The controller 26 may bleed the excess charge from the one or more battery cells 12 until the one or more battery cells 12 have a similar or substantially the same SoC as illustrated, e.g., in FIG. 1B.

FIG. 3B illustrates an example battery management system 20 implemented on a common substrate. The battery management system 20 may represent a physical implementation of the BMS 14 illustrated in FIG. 3A, where the resistors 18, switches 16 and the controller 26 are integrated on a common circuit board 22. The circuit board 22 includes terminals 24 for electrically connecting to a plurality of battery cells.

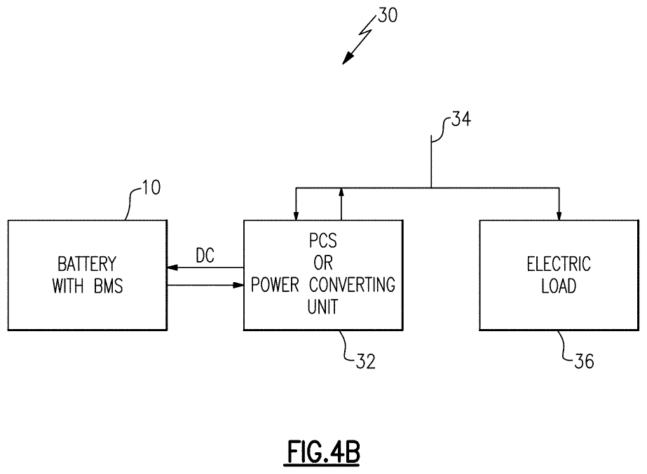

FIG. 4A schematically illustrates an example energy storage system (ESS) 30 configured for a battery system 10 (FIG. 3A) according to embodiments. The illustrated ESS 30 can serve as a base ESS that includes a battery system 10 including a BMS 14 (FIG. 3A) according to embodiments. The ESS 30 additionally includes a power control system (PCS) 32 electrically connected to a grid 34. The PCS 32 is centrally electrically connected to the battery system 10 and an electric load 36. The PCS 32 is configured to receive power, e.g., AC power, from the grid 34 and to control power delivered, e.g., DC power, to the battery system 10 and to the electric load 36. The PCS 32 is further configured to control power delivery from the battery system 10 to the load 36. Thus configured, the PCS 32 is configured to control power delivery between battery system 10 and the grid 34, between the load 36 and the grid 34, and between the battery system 10 and the load 36.

FIG. 4B schematically illustrates another example energy storage system (ESS) 30 configured for a battery system 10 (FIG. 3A) according to embodiments. The illustrated ESS 30 can serve as a base ESS that includes a battery system 10 including a BMS 14 (FIG. 3A) according to embodiments. The ESS 30 includes a power control system (PCS) 32 electrically connected to the grid 34. Similar to the ESS 30 illustrated in FIG. 4A, in the illustrated ESS 30, the PCS 32 is electrically connected to a battery system 10 and a load 36. The PCS 32 is configured to receive power, e.g., AC power, from the grid 34 and to control power delivered, e.g., DC power, to the battery system 10 and to the load 36. However, unlike the ESS 30 illustrated in FIG. 4A, the PCS 32 and the electric load 36 are both connected to the grid.

### Battery Systems Configured for Thermal Management of Battery Cells

As described above, a battery management system (BMS) can be used control the temperature of the battery cells through heating and/or cooling. For heating, in some battery systems, an active heater may be employed to heat the battery cells. The active heater may be powered by an external power source, e.g., an AC power source, or an internal power source, e.g., the battery pack of the battery system. For example, a thermal hydraulic system including an electric heater which heats a fluid that is pumped and distributed throughout the battery pack may be used as an active heater. In some other battery systems, externally generated heat, which may otherwise be wasted, may be harvested. For example, some electric vehicles may be configured to harvest heat generated by a motor, which serves as a load, to heat the battery cells. In these battery systems, a BMS may be employed to manage the heat transfer from the heat source to the battery cell. However, existing heating techniques either involve expending additional energy and/or are dependent on heat that may not be controlled by the battery system. Thus, there is a need to provide a system and method in which heat is controllably and efficiently, using a BMS, provided to the battery cells from the battery cells themselves.

To address at least these needs, disclosed herein is a battery system comprising a plurality of battery cells electrically connected to each other. The battery system comprises a plurality of switches each connected to one of the battery cells. The battery system additionally comprises one or more heaters electrically connected to the switches and configured to generate heat upon activation of one or more switches by dissipating power from the battery cells. The battery system further comprises one or more heat conduits configured to channel the heat generated by the one or more heaters towards at least one of the battery cells to raise a temperature thereof.

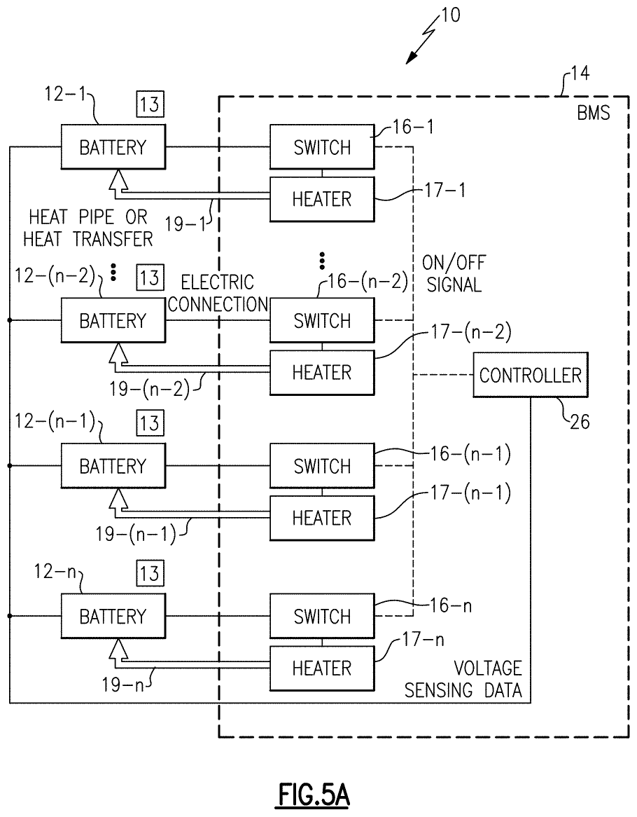

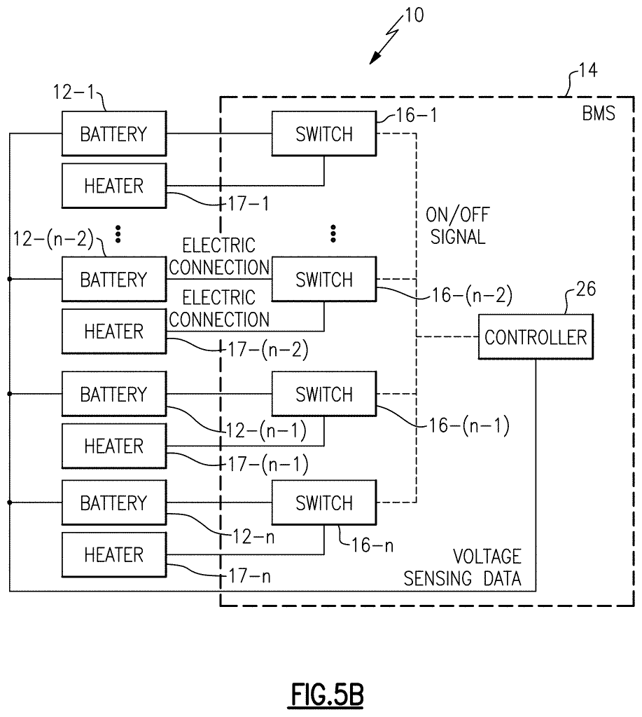

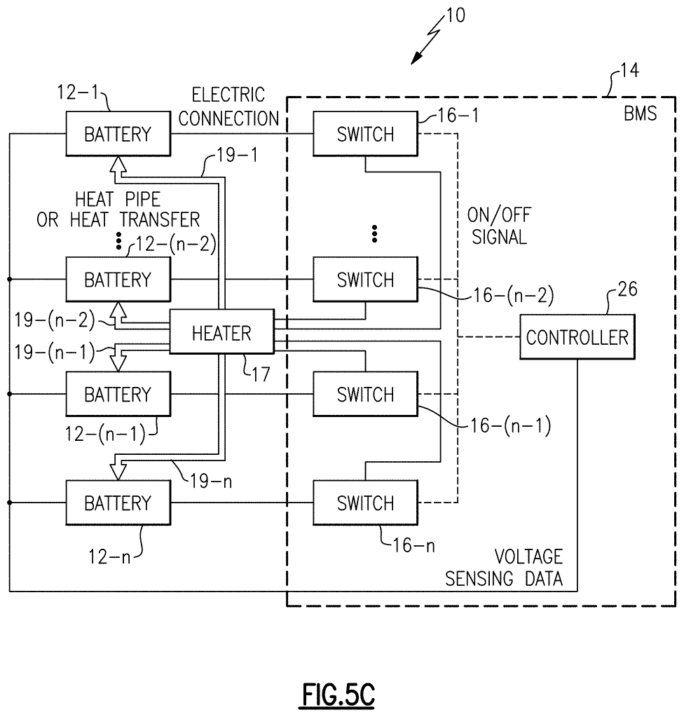

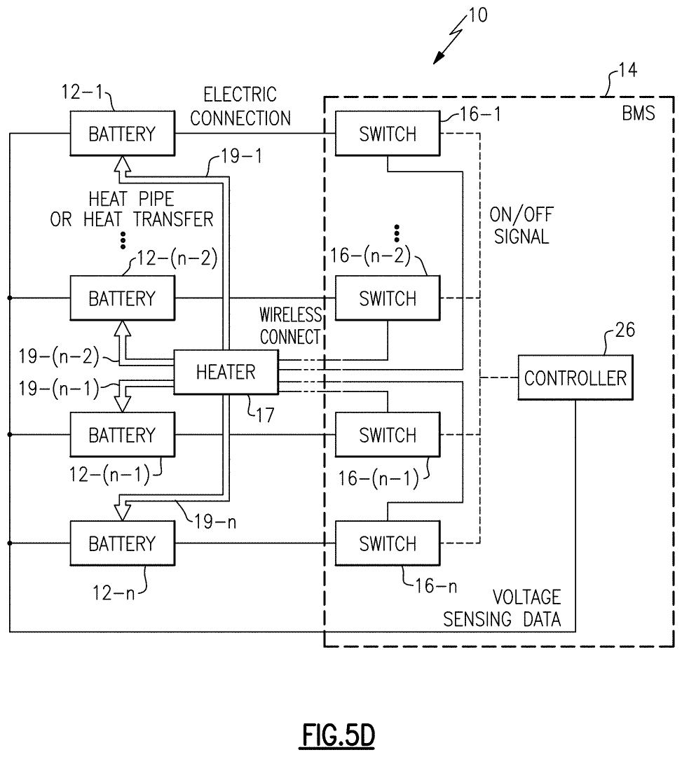

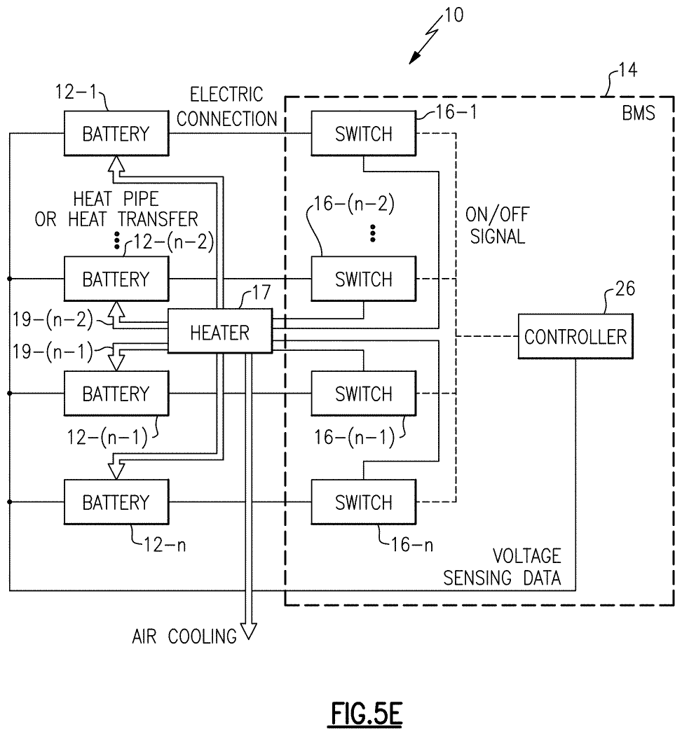

FIGS. 5A-5E schematically illustrate example battery systems 10 configured for thermal management of battery cells 12 according to various embodiments. Each of the illustrated example battery systems 10 include a plurality of battery cells 12-1, . . . , 12-(n−2), 12-(n−1), 12-n (collectively referred to herein as battery cells 12) and a battery management system (BMS) 14. The plurality of battery cells 12 are electrically connected to each other, in electrical series and/or parallel. The battery system 10 additionally comprises a plurality of switches 16-1, . . . , 16-(n−2), 16-(n−1), 16-n (collectively switches 16) each connected to one of the battery cells 12. The battery system 10 additionally comprise one or more heaters 17-1, . . . , 17-(n−2), 17-(n−1), 17-n (collectively referred to herein as heaters 17), which serve as effective heat sources, electrically connected to the switches 16. The battery system 10 may further comprises a controller 26 configured to sense states of charge (SoC) of the battery cells 12 and to selectively activate one or more switches 16 based on the SoC. The heaters 17 are electrically connected to the switches 16 and configured to generate heat upon activation of one or more switches 16 connected thereto by dissipating power from the battery cells 12. The heater 17 may include one or more a common resistor, a copper wire, a nichrome wire, a SMD resistor (surface-mount resistor or chip resistor), an electrode boiler and a heat pump.

In order to effectively channel the heat, the battery systems further comprises one or more heat conduits 19-1, . . . , 19-(n−2), 19-(n−1), 19-n (collectively referred to herein as heat conduits 19) configured to channel the heat generated by the one or more heaters 17 towards at least one of the battery cells 12 to raise a temperature thereof by, relative to the same battery system arrangement without one or both of the resistors 18 and the heat conduits 19, by at least 2° C. 5° C., 10° C., 15° C., 20° C., 25° C., 30° C., or a temperature in a range defined by any of these values. In addition to providing heat to the battery cells 12, at least the switches 16 and the heaters 17 can be part of a BMS 14 configured to actively or passively balance the battery cells 12. The controller 26 may be configured to sense a state of charge (SoC) of the battery cells 12 and to selectively activate one or more switches 16 based on the SoC, e.g., when the sensed SoC is outside of a predetermined range. The sensed SoC can be proportional to a battery capacity and is different for different ones of the battery cells 12.

For example, when the controller 26 senses that a SoC of one or more of the battery cells 12 is above a threshold value after charging for a predetermined period by, e.g., measuring voltages thereof, the controller 26 may activate respective ones of the switches 16 connected to the one or more batteries 12 to selectively dissipating excess charge therefrom using respective ones of the heaters 17 connected thereto. The controller 26 may bleed the excess charge from the one or more battery cells 12 until the one or more battery cells 12 have a similar or substantially the same SoC. Thus, the heaters 17 serve a dual function of cell balancing as well as heating the battery cells 12.

According to various embodiments, the controller 26 is configured to activate the one or more switches 16 upon determining that the temperature of the at least one of the battery cells 12 is lower than a predetermined temperature. In some embodiments, the controller 26 is configured to activate the one or more switches 16 after cooling the at least one of the battery cells 12 to a temperature lower than the predetermined temperature. The predetermined temperature may be, e.g., about 15° C., 17° C., 19° C., 21° C., 23° C., 25° C., or a value in a range defined by any of these values, e.g., about 20° C. The controller 26 may be further configured to deactivate activated ones of the one or more switches 16 upon sensing that the temperature of the at least one of the battery cells 12 has increased by at the at least about 2° C., 4° C., 6° C., 8° C., 10° C., or a value in a range defined by any of these values, e.g., about 5° C.

According to various embodiments, the heat generated by the one or more heaters 17 is capable to cause the temperature of the at least one of the battery cells 12 to reach 20° C., 25° C., 30° C., 35° C., 40° C., 45° C., 50° C., or a temperature in a range defined by any of these values, depending on the application of battery system 10 and the type of battery cells 12. For example, when integrated as part of an ESS 30, the battery cells 12 may be heated to be within a range of, e.g., 20-30° C. When the battery cells 12 are redox battery cells, e.g., vanadium ion battery cells, the battery cells 12 may be heated to be within 15-40° C.

The one or more heaters 17 may serve as an effective heat source as well as a cell balancing resistor 18, simultaneously, if the one or more heaters 17 have a resistance of 100 mΩ-100Ω, 200 mΩ-10Ω, 500 mΩ-1Ω, or a value in a range defined by any of these values.

Still referring collectively to FIGS. 5A-5E, the heat conduit 19 can comprise any suitable heat conducting medium for efficiently conducting heat from the heaters 17 to the battery cells 12. In some embodiments, the heat conduits 19 comprise air conduits configured to channel the heat by convection. In some other embodiments, the heat conduits comprise heat conducting pipes configured to channel the heat by conduction.

FIG. 5A schematically illustrates an example battery system 10 configured for thermal management of battery cells 12, according to some embodiments. In the illustrated battery system 10, each of the battery cells 12 is connected to a dedicated one of the heaters 17 by a dedicated one of the conduits 19. In these embodiments, each of the heaters 17 is physically disposed closer to the dedicated one of the switches 16 relative to the dedicated one of the battery cells 12. The switches 16, heaters 17 and the controller 26 are integrated as part of a BMS 14.

In some embodiments, the switches 16, heaters 17 and the controller 26 may be integrated on a common substrate, e.g., in a similar manner as shown in FIG. 3B.

FIG. 5B schematically illustrates an example battery system 10 configured for thermal management of battery cells 12, according to some other embodiments. In the illustrated battery system 10, each of the battery cells 12 is connected to a dedicated one of the heaters 17 by a dedicated one of the conduits 19. However, unlike the battery system 10 illustrated in FIG. 5A, in these embodiments, each of the heaters 17 is physically disposed closer to the dedicated one of the battery cells 12 relative to the dedicated one of the switches 16. In the illustrated arrangement, the switches 16 and the controller 26 are integrated as part of a BMS 14, while the heater 17 may be formed outside of the BMS 14, e.g., integrated as part of a battery pack.

In the battery systems 10 described with respect to FIGS. 5A and 5B, a dedicated heater 17 is provided for each of the battery cells 12. However, embodiments are not so limited and in other embodiments, there may be fewer or more heaters 17 than the battery cells 12 configured to heat multiple battery cells 12. For example, one central heater 17 may be configured to channel heat to each of the battery cells 12, as described herein.

FIG. 5C schematically illustrates an example battery system 10 configured for thermal management of battery cells 12, according to some other embodiments. In the illustrated battery system 10, one or more heaters 17, e.g., a single P2H element, is centrally electrically connected to multiple switches 16 each connected to a battery cell 12. The single heater 17 is configured to dissipate power from the battery cells 12 upon activation of one or more switches 16. The single heater 17 may be composed of a plurality of resistors 18 installed on one circuit board. The single heater 17 is centrally thermally connected to multiple battery cells 12 through one or more heat conduits 19, e.g., dedicated heat conduits. Similar to the battery system 10 illustrated in FIG. 5B, the switches 16 and the controller 26 are integrated as part of a BMS 14, while the heater 17 may be formed outside of the BMS 14, e.g., integrated as part of a battery pack.

FIG. 5D schematically illustrates an example battery system 10 configured for thermal management of battery cells 12, according to some other embodiments. In the illustrated battery system 10, one or more heaters 17, e.g., a single P2H element, is centrally and wirelessly connected to multiple switches 16 each connected to a battery cell 12. The wireless connection is configured for communicatively coupling and wirelessly activating the heater 17 though one or more the switches 16. In a similar manner as the battery system of FIG. 5C, the single heater 17 is in turn centrally thermally connected to multiple battery cells 12 through one or more heat conduits 19, e.g., dedicated heat conduits. Similar to the battery system 10 illustrated in FIG. 5B, the switches 16 and the controller 26 are integrated as part of a BMS 14, while the heater may be formed outside of the BMS, e.g., integrated as part of a battery pack.

In the battery systems described with respect to FIGS. 5A-5D, one or more heaters 17 are configured to be activated upon activation of one or more switches 16. In some embodiments, each of these systems can be configured such that one or more heaters 17 can be actively cooled, e.g., to prevent overheating.

FIG. 5E schematically illustrates an example battery system 10 configured for thermal management of battery cells 12, according to some other embodiments. In the illustrated battery system 10, one or more heaters 17, e.g., a single P2H element, is centrally electrically connected to multiple switches 16 each connected to a battery cell 12, in a similar manner as described with respect to FIGS. 5C and 5D. The heater 17 is actively cooled to dissipate excess heat upon reaching a target temperature. In addition, the example battery system 10 comprises a cooling unit configured to actively cool the heater 17. The cooling unit can include any suitable cooling means, including air cooling and liquid cooling.

### Thermal Management Method for Battery System

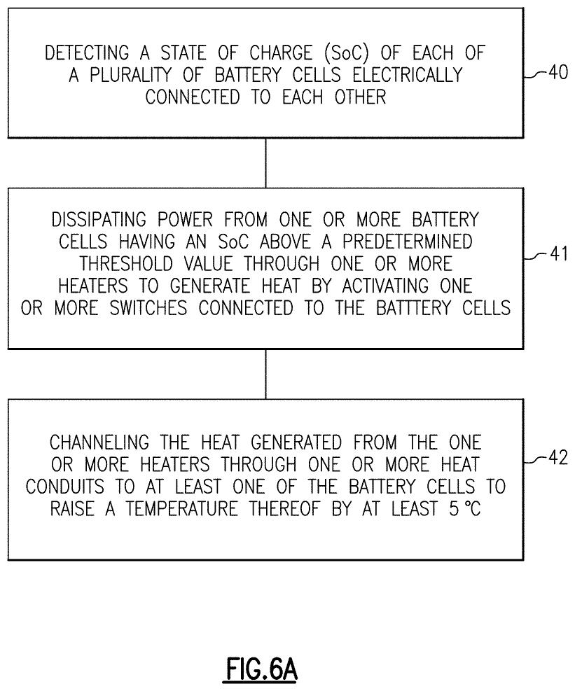

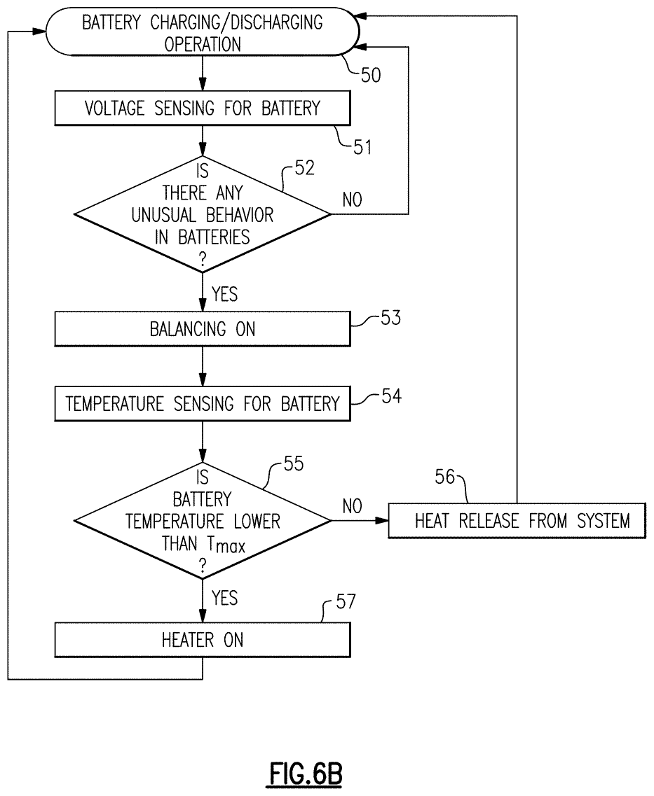

FIG. 6A is a flow chart illustrating a thermal management method for a battery system 10, according to some embodiments. FIG. 6B is a flow chart illustrating a thermal management method for a battery system 10, according to some other embodiments. According to various embodiments, a thermal management method for a battery system 10 comprises detecting 40 a state of charge (SoC) of each of a plurality of battery cells electrically connected to each other. The method additionally comprises dissipating 41 power from one or more battery cells having a SoC above a predetermined threshold value through one or more heaters to generate heat by activating one or more switches connected to the battery cells. The method further comprises channeling 42 the heat generated from the one or more heaters through one or more heat conduits towards at least one battery at least one of the battery cells to raise a temperature thereof by at least 5° C. The thermal management method can be implemented in any of the battery systems 10 disclosed herein.

Referring to FIG. 6A, the method includes detecting 40 a state of charge (SoC) of each of a plurality of battery cells electrically connected to each other.

In some embodiments, prior to detecting 40 the SoC of each of the battery cells as illustrated in FIG. 6A, the battery cells may be charged or discharged, as illustrated in step 50 of FIG. 6B. The controller 26 (FIGS. 5A-5E) may detect the SoC of each of the battery cells 12.

Referring to FIG. 6B, in some embodiments, detecting the SoC of each of the battery cells comprises measuring or sensing, as illustrated in step 51, a cell voltage of each of the battery cells. The controller may measure the cell voltage of each of the battery cells.

In some embodiments, the method further comprises determining at step 52, from the measured cell voltages of the battery cells, whether an average of the cell voltages has reached a target voltage before proceeding. The controller 26 may determine that the average of the cell voltages has reached the target voltage before proceeding from the measure cell voltages of the battery cells. Upon detecting at step 52 that one or more battery cells have a SoC, e.g., as indicated by battery cell voltages, above a predetermined threshold value, the method may apply a cell balancing scheme to balance the battery cells. On the other hand, upon detecting at step 52 that there is no cell having a SoC or cell voltage above a predetermined threshold value, the method may return to step 50 to charge or discharge the battery cells. For example, the target voltage for charging or discharging may be about 1.0V, 1.5V, 2.0V, 2.5V, 3.0V, or a value in a range defined by any of these values, for instance about 1.2 V.

Still referring to FIG. 6B, after charging or discharging at step 50 and determining that an average of the cell voltages has reached the target voltage at step 52, the method proceeds to determining whether or not to trigger a cell balancing scheme at step 53 and/or heat the battery cells at step 57. The controller 26 may determine whether or not to trigger the cell balancing scheme at step 53 and/or heat the battery cells at step 57. This determination may be based on whether an unusual parameter has been sensed with respect to the battery cells at step 52. For example, an unusual parameter may be a relatively high range of SoCs or cell voltages. In this example, a cell balancing scheme may be triggered upon determining that a range of SoC or a range of cell voltages as measured from the battery cells 12 is outside a predetermined range. For example, if the range of cell voltages exceeds 20 mV, 40 mV, 60 mV, 80 mV, 100 mV or a value in a range defined by any of these values, e.g., 50 mV, the method triggers a cell balancing scheme at step 53, according to some embodiments, as illustrated in FIG. 6B. That is, the controller may sense the SoC by measuring the cell voltage at step 51 and selectively activate one or more switches upon measuring a range of cell voltage greater than about 50 mV.

Referring back to FIG. 6A, the method additionally comprises, after detecting the SoC, dissipating 41 power from one or more battery cells having an SoC above a predetermined threshold value through one or more heaters to generate heat by activating one or more switches 16 connected to the battery cells 12. The controller 26 may dissipate power from one or more battery cells 12. Dissipating power may occur upon triggering a cell balancing scheme. For example, the cell balancing scheme according to step 53 illustrated in FIG. 6B may be configured to selectively dissipate power from battery cells having a SoC, e.g., cell voltage, above the predetermined value. For example, the predetermined value may be an average cell voltage. For example, if the target charge/discharge voltage is 1.2V, the switches 16 corresponding to the battery cells having a cell voltage greater than 1.2V are activated, thereby triggering the cell balancing scheme at step 53. That is, the controller 26 may sense the SoC by measuring a cell voltage at step 51 as shown in FIG. 6B and selectively activate one or more switches upon measuring an average cell voltage greater than about 1.2 V.

Still referring to FIG. 6A, in conjunction with dissipating power, the method further comprises channeling 42 the heat generated from the one or more heaters 17 through one or more heat conduits 19 towards at least one of the battery cells 12 to raise a temperature thereof by at least 5° C. In some embodiments, prior to channeling the heat, a temperature control loop may be initiated to sense the temperature of the battery cells as shown in step 54 of FIG. 6B, to determine whether the battery cells 12 should be heated as shown in step 55 of FIG. 6B. In these embodiments, the method additionally comprises, prior to channeling the heat, measuring a temperature of at least one of the battery cells. The temperature of the battery cells 12 may be measured using one or more temperature sensors 13 disposed adjacent to one or more battery cells 12.

Upon determining that the measured temperature exceeds a predetermined value at step 55, the method may proceed to cool the battery cells to a temperature lower than a predetermined temperature as shown in step 56 of FIG. 6B instead of activating the switches to heat the battery cells. In this case, the method returns to the beginning of the method to step 50 shown in FIG. 6B.

On the other hand, upon determining that the measured temperature does not exceed the predetermined value at step 55, the method proceeds to channel the heat at step 57 of FIG. 6B. According to embodiments, the predetermined temperature may be 20° C., 25° C., 30° C., 35° C., 40° C., 45° C., 50° C., or a value in a range defined by any of these values, depending on the application of battery system 10 and the type of battery cells 12. For example, when integrated as part of an ESS 30, the battery cells 12 may be heated to be within a range of, e.g., 20-30° C. When the battery cells are redox battery cells, e.g., vanadium ion battery cells, the battery cells may be heated to be within 15-40° C.

After the battery cell has been heated to the predetermined temperature or the heating has been initiated at step 57, the method proceeds to charge or discharge the battery cells at step 50, as illustrated in FIG. 6B.

### Energy Storage Systems Configured for Thermal Management of Battery Cells

According to various embodiments described above, thermal management of battery cells 12 of a battery system 10 can be performed using one or more heaters 17 electrically configured to generate heat upon activation by dissipating power from the battery cells 12, and further using one or more heat conduits 19 configured to channel the heat generated by the one or more heaters 17 towards at least one of the battery cells 12. When integrated as part of an energy storage system (ESS) 30, further or alternative thermal management features can be implemented, as described herein.

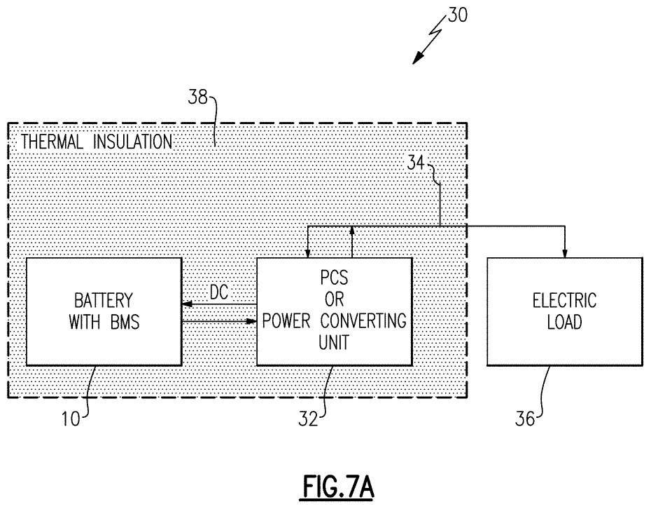

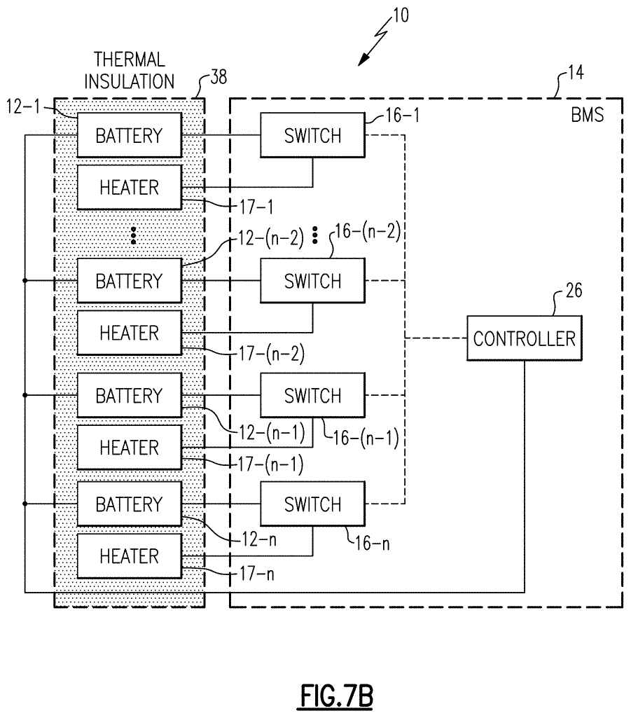

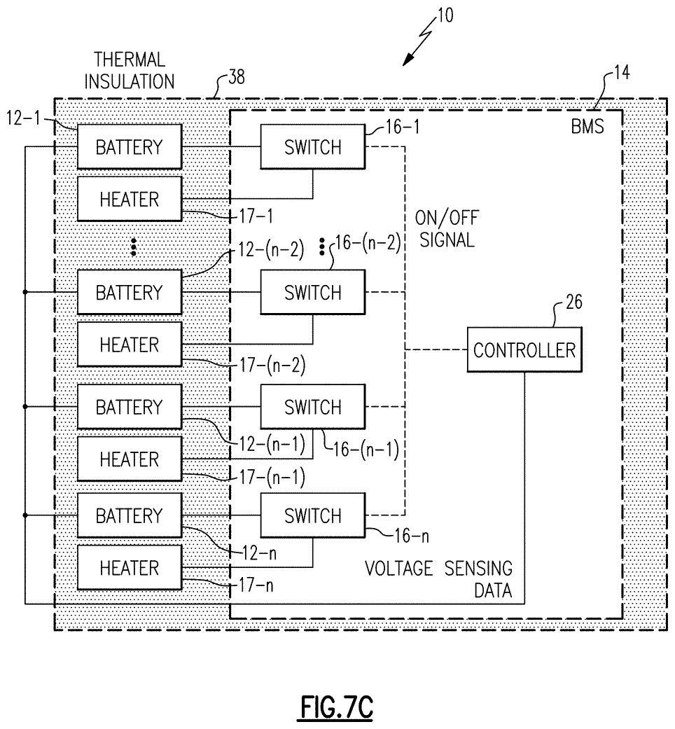

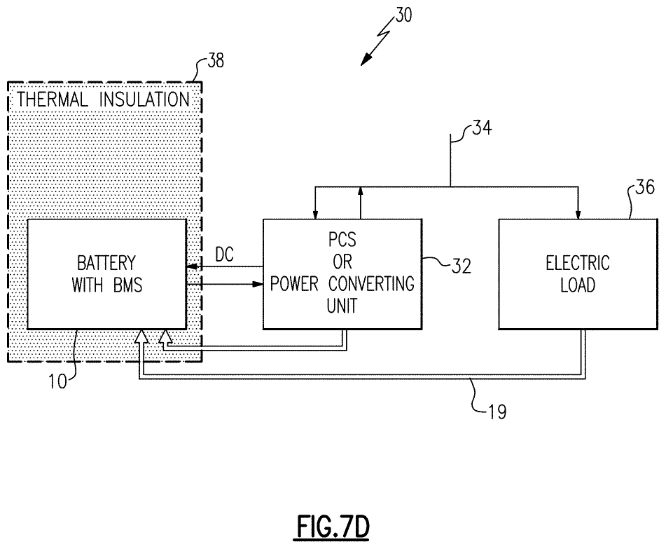

FIG. 7A schematically illustrates an energy storage system 30 configured for thermal management of battery cells 12, according to various embodiments. The illustrated ESS 30 can include similar features as described above with respect to FIG. 4B, the details of which are omitted herein for brevity. However, it will be understood that in other embodiments, the ESS 30 can be configured in a similar manner as illustrated in FIG. 4A. The illustrated the PCS 32 is electrically connected to a battery system 10 and a load 36. In a similar manner to the ESS 30 described above with respect to FIG. 4B, The PCS 30 is configured to receive power, e.g., AC power, from the grid 34 and to control power delivered, e.g., DC power, to the battery system 10 and to the load 36.

Referring to FIG. 7A, the illustrated energy storage system (ESS) 30 comprises a battery system 10 comprising a plurality of battery cells 12 electrically connected to each other, a plurality of switches 16 each connected to one of the battery cells 12, and one or more heaters 17 (or resistors 18) electrically connected to the switches 16 for actively or passively balancing states of charge (SoC) of the battery cells 12. The ESS 30 additionally may comprise a power control system (PCS) 32 electrically connected to the battery system 12. The ESS 30 may further comprise an electric load 36 electrically connected to the PCS 32.

In some embodiments, one or both of the PCS 32 and the electric load 36 are configured to be electrically connected to a grid 34. In addition, one or more of the battery system 10 and the PCS 32 are thermally insulated by a thermal insulator 38 other than air. Without limitation, thermal insulator 38 can include polymeric materials such as polypropylene, polyester or polyimide, paper-based materials or glass-based materials, to name a few. The thermal insulator 38 is configured to harvest heat generated by the PCS 32 to heat the battery cells 12. The thermal insulator 38 is configured to enhance heat preservation for efficient and rapid heating of the battery cells 12 using any of the battery system 10 configurations described above. The inventors have discovered that, to this end, the thermal insulator 38 can have a thermal conductivity of 0.01-0.2, 0.2-0.4, 0.4-0.6, 0.8-1 W/m·K, or a value in a range defined by any of these values. Thus illustrated, the thermal insulation 38 can provide an ESS 30 that is thermally closed, partially or fully, for effective heating of the battery cells 12.

In the illustrated embodiment, the battery system 10 and the PCS 32 are thermally insulated by the thermal insulator 38 other than air. However, embodiments are not so limited and in other embodiments, one or more of the battery system 10, the PCS 32 and the electric load 36 may be thermally insulated from each other by the thermal insulator 38 other than air. For example, in some embodiments, the battery system 10, the PCS 32 and the load 36 may be thermally insulated by the thermal insulator 38.

As described herein, electric load 36 can be any component, device, apparatus or system that is intended to be powered by the battery system 10. Examples of the electric load 36 include BMS 14, PCS 32, data center, deep learning center, blockchain mining center and electric vehicle, to name a few. In one particular implementation, when the electric load 36 includes an electric vehicle, heat generated by the electric vehicle can further be harvested to heat the battery cells 12. In this implementation, a charging station or a garage housing the electric vehicle can be considered to be included as part of a thermally-closed ESS system 30.

According to various embodiments, when the battery system 10 is thermally insulated, one or more components thereof may be selectively insulated. That is, any one of the battery cells 12, the switches 16, the one or more heaters 17 and the one or more heat conduits 19 of the battery systems 10 as described above can be encapsulated in a thermal insulator 38 other than air. FIGS. 7B and 7C illustrate two example implementations.

FIG. 7B schematically illustrates a battery system 10 configured for thermal management of battery cells, according to some embodiments. In the illustrated embodiment, the battery cells 12 and the one or more heaters 17 are encapsulated in the thermal insulator 38. For example, a battery rack housing the battery cells 12 can be thermally insulated, and the battery cells 12 and the heaters 17 can be housed therein.

FIG. 7C schematically illustrates a battery system 10 configured for thermal management of battery cells 12, according to some other embodiments. In the illustrated implementation, the battery cells 12 and the one or more heaters 17 are encapsulated in the thermal insulator 38, in a similar manner as the embodiment illustrated in FIG. 7B. In addition, in the illustrated embodiment, the BMS 14 including the switches 16 and the controller 26 are also encapsulated. For example, a battery rack housing the battery cells 12 can be thermally insulated, and the battery cells 12, the heaters 17 and the BMS 14 can be housed therein.

FIG. 7D schematically illustrates an energy storage system 30 configured for thermal management of battery cells 12, according to various other embodiments. The illustrated ESS can include similar features as described above with respect to FIG. 4B and FIG. 7A, the details of which are omitted herein for brevity. However, it will be understood that in other embodiments, the ESS 30 can be configured in a similar manner as illustrated in FIG. 4A.

Referring to FIG. 7D, the illustrated energy storage system (ESS) 30 comprises a battery system 10 comprising a plurality of battery cells 12 electrically connected to each other, a plurality of switches 16 each connected to one of the battery cells 12, and one or more heaters 17 (or resistors 18) electrically connected to the switches 16 for actively or passively balancing states of charge (SoC) of the battery cells 12. The ESS additionally comprises a power control system (PCS) 32 electrically connected to the battery system 10. The ESS 32 additionally comprises an electric load 36 electrically connected to the power control unit 32. One or both of the PCS 32 and the electric load 36 are thermally connected to the battery system 10 by one or more heat conduits 19 configured to channel heat generated by the one or both of the PCS 32 and the electric load 36 towards the at least one of the battery cells 12 to raise a temperature thereof. The battery system 10 can be in accordance with any embodiment described above.

According to various embodiments, the heat conduit 19 can comprise any suitable heat conducting medium for efficiently conducting heat from the PCS 32 and/or the electric load 36 to the battery cells 12. In some embodiments, the heat conduits 19 comprise air conduits configured to channel the heat by convection. Air conduits can include, e.g., at least partially enclosed tubular conduits configured to channel heated air. In some other embodiments, the heat conduits 19 comprise heat conducting pipes configured to channel the heat by conduction. Heat conducting pipes can include, e.g., solid or hollow pipes that may be filled with a heat-conductive medium such as metal or other solid state heat-conductive material. In yet some other embodiments, the heat conduits 19 comprise heat conducting pipes or conduits configured to channel the heat by a combination of conduction and convection. The heat conducting pipes can include, e.g., hollow pipes that may be filled with a heat-conductive medium such as a liquid that is heated by the one or both of the PCS 32 and the electric load 36 by conduction, which then caries the heated liquid to the battery cells 12 by convection.

Still referring to FIG. 7D, in the illustrated embodiment, the battery system 10 is thermally insulated while the PCS 32 and the electric load 36 are not thermally insulated. However, the illustrated configuration is by way of example only, and embodiments are not limited thereto. For example, according to other embodiments, one or both of the PCS 32 and the electric load 36 can be thermally insulated from each other by a thermal insulator 38 other than air, as described above with respect to FIG. 7A.

Furthermore, according to various embodiments, when the battery system 10 is thermally insulated, one or more components thereof may be selectively insulated. That is, any one of the battery cells 12, the switches 16, the one or more heaters 17 and the one or more heat conduits 19 of the battery systems 10 as described above can be encapsulated in a thermal insulator 38 other than air. FIGS. 7A and 7B illustrate two example implementations.

Redox Battery Systems with Thermal Management

As discussed above, competing factors that are weighed in the selection and design of a suitable electrochemical energy storage system for a particular application includes investment cost, power, energy, lifetime, recyclability, efficiency, scalability and maintenance costs, among others. Among various electrochemical energy storage systems, redox batteries (RBs) are considered to be promising for stationary energy storage. RBs are electrochemical energy conversion devices, that exploit redox processes of redox species dissolved in a solution. Advantageous features of the RBs include relative safety, independent scalability of power and energy, high depth of discharge (DOD), and reduced environmental impact. Such features allow for wide ranges of operational powers and discharge times, making RBs desirable for storage of electricity generated from renewable sources.

In the context of battery systems disclosed herein, RBs can be particularly suitable for various embodiments of battery systems, thermal management methods and energy storage systems disclosed herein. One of the advantages arises from the fact that the redox chemical reactions that govern the charging and discharging of redox batteries can accelerate at elevated temperatures, e.g., according to an Arrhenius behavior. While reaping this benefit, because concerns over overheating and/or explosion is relatively lower for RBs compared to lithium ion batteries, the RBs can be particularly suitable for implementation of various embodiments of thermal management disclosed herein.

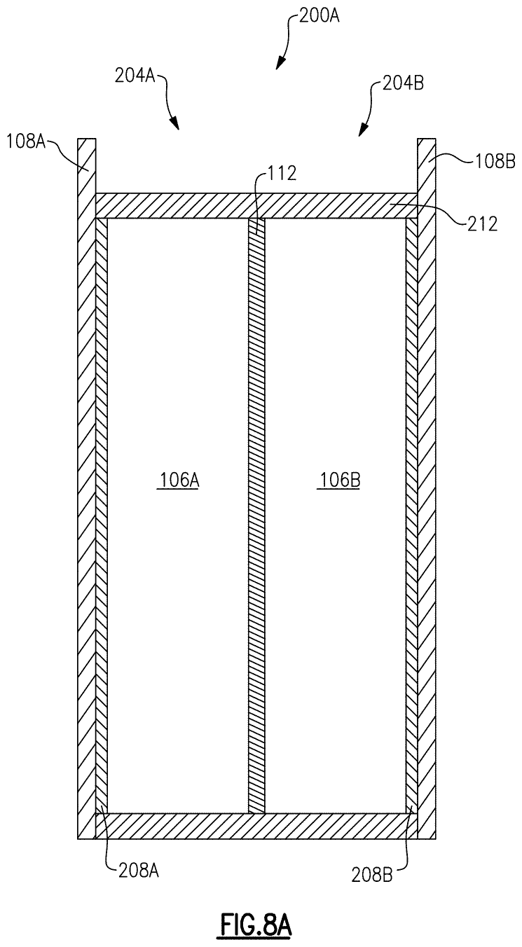

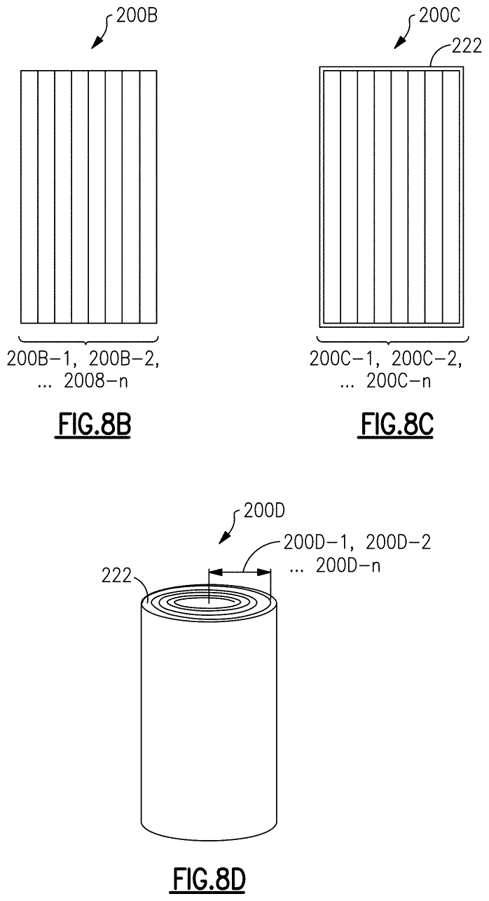

Thus, according to various embodiments of disclosed herein, thermal management features are directed to a redox battery. FIG. 8A is a schematic illustration of a redox battery, according to embodiments. The illustrated redox battery 200A comprises a first half cell 204A and a second half cell 204B. The first half cell 204A comprises a positive electrolyte reservoir 106A having disposed therein a first or positive electrolyte contacting a positive electrode. The first electrolyte has dissolved therein a first redox couple configured to undergo a first redox half reaction. The second half cell 204B comprises a negative electrolyte reservoir 106B having disposed therein a second or negative electrolyte contacting a negative electrode. The second electrolyte has dissolved therein a second redox couple configured to undergo a second redox half reaction. The positive and negative electrolyte reservoirs 106A, 106B define reaction spaces for the respective half reactions. The redox battery 200A additionally comprises an ion exchange membrane 112 separating the positive electrolyte reservoir 106A and the negative electrolyte reservoir 106B. The positive electrode is electrically connected to a positive current collector 108A and the negative electrode is electrically connected to a negative current collector 108B. In some implementations, a first bipolar plate 208A is interposed between the positive current collector 108A and the positive electrolyte reservoir 106A, and a second bipolar plate 208B is interposed between the negative current collector 108B and the negative electrolyte reservoir 106B.

Unlike conventional RBs, in the redox battery 200A, the first half cell 204A, the second half cell 204B and the ion exchange membrane 112 define a redox battery cell that is enclosed in a casing or a frame 212. The casing 212 is such that under normal operation, internal contents thereof may not be physically accessible from the outside. That is, the positive and negative electrolytes are not in fluidic communication with external containers such as electrolyte tanks. The casing 212 may seal the redox battery 200A hermetically and/or permanently. Such configuration is in contrast to conventional redox flow batteries, in which the redox battery cell is in fluidic communication with external tanks. That is, in some redox batteries, neither of the positive electrolyte reservoir 106A or the negative electrolyte reservoir 106B in the enclosed cell is in fluidic communication with or physically connected to a separate electrolyte tank that stores a respective one of the first or second electrolytes. As such, substantially the entire volume of the positive and negative electrolytes is stored within the redox battery cell and enclosed by the casing 212. That is, the first electrolyte reservoir 106A stores substantially the entire volume of the first electrolyte for the first half cell 204A, and the second electrolyte reservoir 106B stores substantially the entire volume of the second electrolyte for the second half cell 204B. In part because the redox battery 200A is not connected to a separate storage tank, the redox battery 200A advantageously does not include the conduits for transferring electrolytes to and from the battery cell, nor the pumps for circulating the electrolytes.

As described above, a notable structural distinction of the redox battery 200A, relative to some conventional redox batteries such as redox flow batteries (RFBs) is the omission of pumps. Instead, the redox battery 200A according to embodiments are configured such that the first and second electrolytes self-circulate within respective ones of the positive electrolyte reservoir 106A of the first half cell 204A and the negative electrolyte reservoir 106B of the second half cell 204B. In various configurations, self-circulation of the first and second electrolytes is caused by one or more of: an osmotic pressure difference between the first and second electrolyte reservoirs; a density change in one or both of the first and second electrolytes; diffusion or migration of one or both of the first and second electrolytes; an affinity of one or both of the first and second electrolytes toward a respective ones of the first and second electrodes; the first and second redox half reactions; and thermal expansion or contraction of one or both of the first and second electrolytes. The inventors have discovered that self-circulation is effective to provide stability of the power and energy output when the thicknesses of the positive and negative electrolyte reservoirs 106A, 106B in the cross-sectional view of FIG. 8A do not exceed 20 cm, 15 cm, 10 cm, 5 cm, 2 cm, 1 cm or a value in a range defined by any of these values.

Still referring to FIG. 8A, the casing 212 is formed of a suitable corrosion resistant material to accommodate the positive and negative electrolytes, which can be highly acidic. In addition to providing corrosion resistance, the casing 212 may be a rigid casing to provide mechanical support for the redox battery 200A. In some embodiments, at least portions of the casing 212 according to embodiments may be formed of a flexible material that is configured to deform to accommodate changes in internal pressure within the positive and negative electrolyte reservoirs 106A, 106B. The increase in internal pressure may be caused, e.g., due to various effects described infra with respect to pressure-controlled redox batteries. In configurations where only portions of the casing are formed of a flexible material, remaining portions may be formed of a rigid material. The flexible portions may be configured to, e.g., expand in response to an increase in pressure such that one or both of the positive and negative electrolyte reservoirs 106A, 106B may accommodate in increase in respective volume that is greater than 0.1%, 0.2%, 0.5%, 1%, 2%, 5%, 10%, 20%, 50%. The suitable material of the casing 212 can include polyvinyl chloride (PVC), polyethylene (PE), polystyrene (PS), polypropylene (PP), polycarbonate (PC), ABS, reinforced plastics, and the like.

Thus configured, the redox battery 200A provides various technical and commercial advantages. For example, various reliability failures associated with the conduits, e.g., pipe joints, between the battery cell and the tanks, as well as pumps for circulating the electrolytes, are substantially reduced or eliminated, which in turn reduces unscheduled repairs as well as safety hazard and operational cost associated with operation of the redox battery 200A. In addition, extrinsic efficiency is substantially improved by obviating a need to circulate the electrolyte between the battery cell and the tanks using pumps. The inventors have realized that depending on the size of the system, the redox battery 200A can improve the power or energy density by up to 2-50 times compared to conventional RFBs by obviating a need to circulate the electrolyte between the cell and the electrolyte tanks. As described above, a power or energy density refers to the power or energy output of a storage device relative to the total volume of the energy storage device, respectively. Thus, for a redox battery, the power or energy density refers to a ratio of the power or energy output to the total volume of the redox battery, respectively. In addition, the space efficiency is greatly improved by the omission of a circulation system including separate tanks, pumps and conduits. Furthermore, the system complexity is greatly reduced, thereby greatly reducing the barrier to commercial implementation of the redox battery 200A. For example, unlike conventional RFBs, the redox battery 200A can be manufactured in packs similar to lithium ion batteries for modularized implementation, rendering them more adapted for automation and mass production, without a need for intrusive construction that may be needed for installing conventional RFBs.

In the following, the operating principle and aspects of the redox battery 200A are described using an example of a vanadium (V) redox battery, which is based on vanadium-based redox pairs. However, it will be understood that embodiments are not so limited, and the principles described herein can be applied to redox batteries according to various other redox pairs.

In a V redox battery according to embodiments, the first redox couple dissolved in the first or positive electrolyte of the first half cell 204A may be a V⁴⁺/V⁵⁺ redox couple, and the second redox couple dissolved in the second or negative electrolyte of the second half cell 204B may be a V²⁺/V³⁺ redox couple. The redox reactions during charging and discharging can be described using the following equations, where → denotes a discharge reaction direction and ← denotes a charging reaction direction:

Second half cell/Negative electrode: V²⁺↔V³⁺+e⁻

First half cell/Positive electrode: V⁵⁺+e⁻↔V⁴⁺

Overall reaction: V²⁺+V⁵⁺↔V³⁺+V⁴⁺

During charging, in the first half cell 204A, tetravalent vanadium ions V⁴⁺ is oxidized to pentavalent vanadium ions V⁵⁺, while in the second half cell 204B, trivalent ions V³⁺ are reduced to bivalent ions V²⁺. During discharging, in the first half cell 204A, pentavalent vanadium ions V⁵⁺ is reduced to tetravalent vanadium ions V⁴⁺, while in the second half cell 204B, bivalent ions V²⁺ are oxidized to trivalent ions V³⁺. While these redox reactions occur, electrons are transferred through an external circuit and certain ions diffuse across the ion exchange membrane 112 to balance electrical neutrality of positive and negative half cells, respectively.

Other redox reactions can be implemented in the redox battery 200A according to embodiments. According to various embodiments, the first redox couple or the second redox couple includes ions of one or more of vanadium (V), zinc (Zn), bromine (Br), chromium (Cr), manganese (Mn), titanium (Ti), iron (Fe), cerium (Ce) and cobalt (Co). In some embodiments, the first and second redox couples include ions of the same metal, as in the V redox battery described above. In these embodiments, advantageously, mixing of the positive and negative electrolytes does not lead to cross-contamination of the electrolytes.

As described herein, an electrolyte of a redox battery is a solution that conducts current through ionization. The electrolyte serves to support the reduced and oxidized forms of a redox couple and also supports the corresponding cations and anions in order to balance the charge of the ions in solution during the oxidation and reduction of the redox couple. The positive and negative electrolytes according to embodiments comprise an aqueous acidic solution. For a V redox battery, the concentration of V ions relates to the energy density of the electrolytes. Higher energy density can advantageously serve to reduce the volume of the positive and negative electrolyte reservoirs 106A, 106B needed for a given amount of energy and power output. However, the concentration of V ions that is too high can lower the stability of the V ions. Thus, there is an optimum range of V ions for a given application. For example, vanadium ions dissolved in the one or both of the first and second electrolyte can be greater than 1.0 M, 1.5 M, 2.0 M, 2.5 M or a value in a range defined by any of these values. On the one hand, V ion concentrations that are lower than 1.0 M can result in energy levels that are not suitable for some applications. On the other hand, V ion concentrations that are greater than 2.5 M can result in lower stability of the V⁵⁺ ions, e.g., at operating temperatures above 50° C., and can approach the solubility limit of V²⁺ and V³⁺ ions in the electrolyte, e.g., at operating temperatures below −20° C.

Advantageously, according to embodiments, the positive and negative electrolytes can include the same solvent(s) and/or ions of the same metal. In these embodiments, mixing of the positive and negative electrolytes through the ion exchange membrane 112 does not result in contamination of the respective half cells. In addition, the positive and negative electrolytes may be prepared from the same starting solvent(s) and solute(s). For example, for a V redox battery according to some embodiments, both the positive and negative electrolytes comprise sulfuric acid. The electrolytes can be prepared by, e.g., dissolving 0.1 M to 2.5 M VOSO₄ (vanadylsulfate) in 0.1 M to 6 M H₂SO₄ in aqueous solution, to form tetravalent vanadium ions (V⁴⁺) and/or trivalent vanadium ions (V³⁺). The tetravalent/trivalent vanadium ions can be electrochemically oxidized to form the positive electrolyte (catholyte), which contains a solution of pentavalent vanadium ions (V⁵⁺). Conversely, the tetravalent/trivalent vanadium ions can be electrochemically reduced to form the negative electrolyte (anolyte), which contains a solution of a divalent vanadium ions (V²⁺).

Still referring to FIG. 8A, in various embodiments, the positive and negative electrodes disposed in the positive and negative electrolyte reservoirs 106A, 106B, respectively, comprise carbon-based materials, such as carbon or graphite felts, carbon cloth, carbon black, graphite powder and graphene, to name a few. The carbon-based materials advantageously provide relatively high operation range, good stability and a high reversibility. The electrodes are optimized for relatively high electrochemical activity, low bulk resistivity and large specific area. The improvement of the electrochemical activity of the electrode increases the energy efficiency of the redox battery 200A. To improve the performance of the redox battery 200A, the surfaces of the electrode may be modified, e.g., by coating with a metal, increasing surface roughness, or doping with additives.

The positive and negative electrolyte reservoirs 106A, 106B defining the reaction spaces are partly or completely filled with respective electrodes between the ion exchange membrane 112 and the first and second bipolar plates 208A, 208B respectively when present, or between the ion exchange membrane 112 and the positive and negative current collectors 108A, 108B respectively. The remaining spaces of the positive and negative electrolyte reservoirs 106A, 106B after filling with respective electrodes are partly or completely filled with respective electrolytes between the ion exchange membrane 112 and the first and second bipolar plates 208A, 208B when present, or between the ion exchange membrane 112 and the positive and negative current collectors 108A, 108B. In various embodiments, except when intentionally perforated or rendered porous as described below, the ion exchange membrane 112 serves to substantially separate the two half-cells, and to substantially prevent the mixing of the two electrolytes and the redox couples, while allowing the transport of ions such as H⁺ to balance the charge between the two half cells to complete the circuit during passage of current. The ion exchange membrane 112 can be an anion exchange membrane or a cation exchange membrane. The ion exchange membrane 112 can include perfluorinated ionomers, partially fluorinated polymers and non-fluorinated hydrocarbons to name a few categories of materials. Particular examples of ion exchange membrane 112 include Nation®, Flemion®, NEOSEPTA-F® and Gore Select®, which provide good chemical stability, high conductivity and mechanical strength.

While various illustrated embodiments include an ion exchange membrane 112 that can be selective to a particular type of ion, e.g., a cation or an anion, embodiments are not so limited. For example, in various embodiments, the ion exchange membrane 112 can be a non-selective membrane, e.g., a porous membrane.

Still referring to FIG. 8A, in some embodiments, the output power may be scaled by connecting a number of single redox battery cells, e.g., in series, to form a cell stack. In these configurations, first and second bipolar plates 208A, 208B may facilitate the series connection of the single cells and the current collecting plate 108A, 108B between adjacent bipolar plates can be removed. The first and second bipolar plates 208A, 208B may be formed of a suitable material such as graphite, carbon, carbon plastic or the like to provide high electrical conductivity and low internal resistance of the cell stack. Additionally, the first and second bipolar plates 208A, 208B support the contact pressure to which they are subjected when pressed against the electrodes to increase electrical conductivity. In addition, the first and second bipolar plates 208A, 208B are provided to have high acid resistance to prevent corrosion or oxidation of the current collecting plates 108A, 108B.

The positive and negative current collectors 108A, 108B comprise a metal having high electrical conductivity, such as copper or aluminum, and serve to flow electrical current during the charging and discharging processes.

As a single redox battery 200A described above has an output voltage that is characteristic of the electrochemical reaction, e.g., about 1.65 V or less additional cells may be connected in electrical series or in electrical parallel to achieve higher voltages and currents, respectively, as described herein.

FIG. 8B is a schematic illustration of a redox battery comprising a plurality of redox battery cells in a stacked configuration, according to some embodiments. The illustrated redox battery 200B includes a plurality of battery cells 200B-1, 200B-2, . . . , 200B-n, which can be stacked, where each cell is configured in a similar manner as the redox battery 200A (FIG. 8A). Each of the plurality of battery cells 200B-1, 200B-2, . . . , 200B-n includes a positive electrolyte reservoir 106A, a negative electrolyte reservoir 106B and an ion exchange membrane 112. In the illustrated embodiment, each of the plurality of battery cells 200B-1, 200B-2, . . . , 200B-n is enclosed by a separate casing 212. The plurality of battery cells 200B-1, 200B-2, . . . , 200B-n may be connected in electrical series to increase the output voltage.

FIG. 8C is a schematic illustration of redox battery comprising a plurality of redox battery cells in a stacked configuration, according to some other embodiments. The illustrated redox battery 200C includes a plurality of battery cells 200C-1, 200C-2, . . . , 200C-n, which can be stacked, where each of the plurality of battery cells 200C-1, 200C-2, . . . , 200C-n is configured in a similar manner as the redox battery 200A (FIG. 8A), including a positive electrolyte reservoir 106A, a negative electrolyte reservoir 106B and an ion exchange membrane 112. However, unlike the redox battery 200B (FIG. 8B), in the illustrated embodiment, the plurality of battery cells 200C-1, 200C-2, . . . , 200C-n are enclosed by a common casing 222. In a similar manner as the redox battery 200B (FIG. 8B), the plurality of battery cells 200C-1, 200C-2, . . . , 200C-n may be connected in electrical series to increase the output voltage. Furthermore, in some embodiments, the positive electrolyte reservoirs 106A of the plurality of battery cells 200C-1, 200C-2, . . . 200C-n may be in fluidic communication with each other, and the negative electrolyte reservoirs 106B of the plurality of battery cells 200C-1, 200C-2, . . . , 200C-n may be in fluidic communication with each other. The redox battery 200C may be configured as a pouch type battery or a rigid case type battery.

FIG. 8D is a schematic illustration of redox battery comprising a plurality of redox battery cells in a cylindrically stacked configuration, according to embodiments. The illustrated redox battery 200D includes a plurality of battery cells 200D-1, 200D-2, . . . , 200D-n, which can be cylindrically stacked, where each of the plurality of battery cells 200D-1, 200D-2, . . . , 200D-n is configured in a similar manner as the redox battery 200A (FIG. 8A), including a positive electrolyte reservoir 106A, a negative electrolyte reservoir 106B and an ion exchange membrane 112. The plurality of battery cells 200D-1, 200D-2, . . . , 200C-n may individually be enclosed in a casing in a similar manner as described above with respect to the redox battery 200B (FIG. 8B). Alternatively, the plurality of battery cells 200D-1, 200D-2, . . . , 200C-n may be enclosed by a common casing 222 in a similar manner as described above with respect to the redox battery 200C (FIG. 8C). In a similar manner as the redox batteries 200B (FIG. 8B), the plurality of battery cells 200D-1, 200D-2, . . . , 200D-n may be connected in electrical series to increase the output voltage. Furthermore, in some embodiments, the positive electrolyte reservoirs 106A of the plurality of battery cells 200D-1, 200D-2, . . . , 200D-n may be in fluidic communication with each other, and the negative electrolyte reservoirs 106B of the plurality of battery cells 200D-1, 200D-2, . . . , 200D-n may be in fluidic communication with each other.

It will be appreciated that some or all of the plurality of battery cells in each of the stacked configurations described above with respect to FIGS. 8B-8C may be connected in electrical series, by suitably electrically connecting current collectors of opposite polarities of some or all of the cells, or in electrical parallel, by suitably electrically connecting current collectors of the same polarity of some of all of the cells.

### Additional Examples

1. A battery system comprises a plurality of battery cells electrically connected to each other, a plurality of switches each connected to one of the battery cells, and one or more heaters electrically connected to the switches and configured to generate heat upon activation of one or more of the switches by dissipating power from the battery cells, in which one or more heat conduits are configured to channel the heat generated by the one or more heaters towards at least one of the battery cells to raise a temperature thereof.

2. A battery system comprises a plurality of battery cells electrically connected to each other, a plurality of switches each connected to one of the battery cells, and one or more heaters electrically connected to the switches and configured to generate heat upon activation of one or more switches by dissipating power from the battery cells, in which the one or more heaters are configured to serve as one or more resistors for actively or passively balancing states of charge (SoC) of the battery cells and to cause a temperature of the battery cells to rise from the heat.

3. The battery system of Example 1 has the one or more heaters that are configured to serve as one or more resistors for actively or passively balancing the states of charge (SoC) of the battery cells.

4. The battery system of Example 2 further comprises one or more heat conduits configured to channel the heat generated by the one or more heaters towards at least one of the battery cells to raise the temperature thereof

5. The battery system any one of the above Examples has the plurality of battery cells that are redox battery cells.

6. The battery system of any one of the above Examples further comprises a controller electrically connected to the battery cells and the switches, in which the controller configured to sense a state of charge (SoC) of each of the battery cells and to selectively activate one or more switches based on the sensed SoC.

7. The battery system of Example 6 has the controller that is configured to selectively activate the one or more switches that are connected to the battery cells from which the SoC has been sensed to be outside of a predetermined range.

8. The battery system of Example 7 utilizes the sensed SoC that is proportional to a battery capacity and is unique to each of the battery cells.

9. The battery system of any one of Examples 6-8 has the controller that is configured to sense the state of charge (SoC) by measuring a cell voltage and to selectively activate one or more switches upon measuring an average cell voltage greater than about 1.2 V.

10. The battery system of any one of Examples 6-9 has the controller that is configured to sense the state of charge (SoC) by measuring a cell voltage and to selectively activate one or more switches upon measuring a range of cell voltage greater than about 50 mV.

11. The battery system of any one of the above Example further comprises a plurality of temperature sensors each configured to measure a temperature of at least one of the battery cells.

12. The battery system of any one of Examples 6-9 has the controller that is configured to activate the one or more switches upon determining that the temperature of the at least one of the battery cells is lower than a predetermined temperature.

13. The battery system of any one of Examples 6-10 has the controller that is configured to activate the one or more switches after cooling the at least one of the battery cells to a temperature lower than a predetermined temperature.

14. The battery system of any one of Examples 6-11 has the controller that is configured to deactivate activated ones of the one or more switches upon sensing that the temperature of the at least one of the battery cells has increased by at the at least 5° C.

15. The battery system of any one of the above Examples utilizes the heat generated by the one or more heaters that is capable to cause the temperature of the at least one of the battery cells to reach 20-30° C.

16. The battery system of any one of the above Examples has the heat conduits that comprise air conduits configured to channel the heat by convection.

17. The battery system of any one of the above Examples has the heat conduits that comprise heat conducting pipes configured to channel the heat by conduction.

18. The battery system of any one of the above Examples utilizes the heat generated by dissipating power from the battery cells that are channeled to the same ones of the battery cells.

19. The battery system of any one of Examples 1-17 utilizes the heat generated by dissipating power from the battery cells that are channeled to different ones of the battery cells.

20. Each of the battery cells in the battery system of any one of the above Examples is a redox battery cell that comprises a first half cell comprising a first electrolyte having dissolved therein a first redox couple configured to undergo a first redox half reaction, a second half cell comprising a second electrolyte having dissolved therein a second redox couple configured to undergo a second redox half reaction, and an ion exchange membrane separating the positive electrolyte reservoir and the negative electrolyte reservoir, in which the redox battery cells store chemical energy in the first and second electrolytes.

21. The battery system of Example 20 has the first redox couple or the second redox couple that includes ions of one or more of vanadium (V), zinc (Zn), bromine (Br), chromium (Cr), manganese (Mn), titanium (Ti), iron (Fe), cerium (Ce) and cobalt (Co).

22. The battery system of Example 21 has the first and second redox couples that comprise V ions.

23. The battery system of any one of the above Examples has the battery cells that are redox battery cells configured as redox flow battery cells comprising separate tanks storing the first electrolyte and the second electrolytes outside of the battery cells.

24. Each of the battery cells of the battery system of any one of the above Examples is connected to a dedicated one of the heaters by a dedicated one of the conduits.

25. Each of the heaters of the battery system of Examples 24 is physically disposed closer to a dedicated one of the switches relative to a dedicated one of the battery cells.

26. The battery system of Example 24 has the switches, heaters and the controller that are integrated as part of a battery management system.

27. The battery system of Example 26 has the switches, heaters and the controller that are integrated on a common substrate.

28. Each of the heaters of the battery system of Example 24 is physically disposed closer to a dedicated one of the battery cells relative to a dedicated one of the switches.

29. The battery system of any Examples 1-23 further comprises a central heater which is centrally electrically connected to multiple switches of the plurality of switches, in which the central heater is centrally thermally connected to multiple battery cells of the plurality of battery cells through the one or more heat conduits.

30. The battery system of any one of Examples 1-23 has the central heater that is centrally wirelessly connected to the multiple switches and is centrally thermally connected to the multiple battery cells through the one or more heat conduits.

31. The battery system of Example 29 or 30 has the central heater that is a single heater.

32. The battery system of any one of the above Examples has the heater that is configured to be actively cooled to dissipate excess heat upon reaching a target temperature.

33. The battery system of any one of the above Examples has the one or more of the heaters that have a resistance of 100 mΩ-100Ω.

34. The battery system of any one of the above Examples has one or more of the battery cells, the switches, the one or more of the heaters and the one or more heat conduits that are encapsulated in a thermal insulator other than air.

35. The battery system of Example 34 has each of the battery cells, the one or more of the heaters and the one or more of the heat conduits that are encapsulated in the thermal insulator.

36. The battery system of Example 34 has each of the battery cells, the switches, the one or more of the heaters and the one or more of the heat conduits that is encapsulated in the thermal insulator.

37. The battery system of any one of Examples 34-36 has the thermal insulator that has a thermal conductivity of 0.01-1 W/m·K.

38. The battery system of any one of the above Examples is electrically connected to one or both of an external power control system and an external electric load, in which the one or both of the external power control system and the external electric load are thermally connected to the battery system by an external heat conduit configured to channel heat generated by the one or both of the external power control system and the external electric load towards the at least one of the battery cells to raise a temperature thereof.

39. The battery system of any one of the above Examples has the one or more heaters that have a resistance of 100 mΩ-100Ω.

40. A thermal management method for a battery system comprises, detecting a state of charge (SoC) of each of a plurality of battery cells electrically connected to each other, dissipating power from one or more of the battery cells having an SoC above a predetermined threshold value through one or more heaters to generate heat by activating one or more switches connected to the battery cells, and channeling the heat generated from the one or more heaters through one or more heat conduits towards at least one of the battery cells to raise a temperature thereof.

41. The battery system used in the method of Example 40 is according to any one of Examples 1-39.

42. The method of Example 40 or 41 further comprises, prior to detecting the SoC, charging or discharging the plurality of battery cells.

43. The method of any one of Example 40-42 further comprises, prior to detecting the SoC, charging or discharging the plurality of battery cells to an average of cell voltage of about 1.0-2.0 V.

44. The step of detecting the SoC in the method of any one of Examples 40-43 comprises measuring a cell voltage, in which, the predetermined threshold value of the SoC corresponds to the average cell voltage.

45. The method of any one of Examples 40-44 further comprises activating a cell balancing scheme based on the detected SoC.

46. The activating the cell balancing scheme step in the method of Example 45, is activated upon determining that a range of cell voltages exceeds a predetermined value of about 50 mV.

47. The method of Example 46 further comprises, upon detecting that the range of cell voltages exceeds the predetermined value, selectively activating the one or more switches connected to the one or more battery cells having the SoC above the predetermined threshold value.

48. The method of any one of Examples 40-46 further comprises detecting a temperature of at least one of the battery cells prior to channeling the heat.

49. The channeling the heat step in the method of Example 48 comprises channeling upon detecting that the temperature of at least one of the battery cells is below a predetermined temperature.

50. Upon detecting that the temperature of at least one of the battery cells is above the predetermined temperature the method of Example 48 further comprises cooling the at least one of the battery cells to a temperature below the predetermined temperature.

51. The channeling the heat step in the method of Example 48 or 49 comprises channeling until the temperature of the at least one of the battery cells reaches at least the predetermined temperature.

52. The battery cells in the method of any one of Examples 48-51 comprise lithium ion battery cells, and wherein the predetermined temperature is 20-30° C.

53. Each of battery cells in the method of any one of Examples 48-52 comprises a redox battery cell, and the predetermined temperature in the method of any one of Examples 48-52 is 30-30° C.

54. An energy storage system (ESS) comprises a battery system comprising a plurality of battery cells electrically connected to each other, a plurality of switches each connected to one of the battery cells, and one or more resistors electrically connected to the switches for actively or passively balancing states of charge (SoC) of the battery cells, a power control system (PCS) electrically connected to the battery system, and an electric load electrically connected to the power control unit, in which one or both of the PCS and the electric load are configured to be electrically connected to a grid, and one or more of the battery system, the PCS and the electric load are thermally insulated from each other by a thermal insulator other than air having a thermal conductivity of 0.01-1 W/m·K.

55. An energy storage system (ESS) comprises a battery system comprising, a plurality of battery cells electrically connected to each other, a plurality of switches each connected to one of the battery cells, and one or more resistors electrically connected to the switches for actively or passively balancing states of charge (SoC) of the battery cells, a power control system (PCS) electrically connected to the battery system, and

an electric load electrically connected to the power control unit, in which one or both of the PCS and the electric load are thermally connected to the battery system by one or more heat conduits configured to channel heat generated by the one or both of the PCS and the electric load towards the at least one of the battery cells to raise a temperature thereof.

56. An energy storage system (ESS) comprises a battery system comprising a plurality of battery cells electrically connected to each other, a plurality of switches each connected to one of the battery cells, and one or more resistors electrically connected to the switches for actively or passively balancing states of charge (SoC) of the battery cells a power control system (PCS) electrically connected to the battery system and

an electric load electrically connected to the power control unit, in which the battery system is in accordance with any one of Examples 1-37.

57. The ESS of Example 54 has one or both of the PCS and the electric load that are thermally connected to the battery system by one or more heat conduits configured to channel heat generated by the one or both of the PCS and the electric load towards the at least one of the battery cells to raise a temperature thereof.

58. The ESS of Example 54 has the battery system that is in accordance with any one of Examples 1-39.

59. The ESS of Example 55 has one or more of the battery system, the PCS and the electric load that are thermally insulated from each other by a thermal insulator other than air having a thermal conductivity of 0.01-1 W/m·K.

60. The ESS of Example 55 has the battery system that is in accordance with any one of Example 1-39.

61. The ESS of Example 56 has one or more of the battery system, the PCS and the electric load that are thermally insulated from each other by a thermal insulator other than air having a thermal conductivity of 0.01-1 W/m·K.

62. The ESS of Example 56 has one or both of the PCS and the electric load that are thermally connected to the battery system by one or more heat conduits configured to channel heat generated by the one or both of the PCS and the electric load towards the at least one of the battery cells to raise a temperature thereof by at least 5° C.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or whether these features, elements and/or states are included or are to be performed in any particular embodiment.

While certain embodiments have been described, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various embodiments described above can be combined to provide further embodiments. The various features and processes described above may be implemented independently of one another, or may be combined in various ways. All possible combinations and subcombinations of features of this disclosure are intended to fall within the scope of this disclosure.

What is claimed is:

1. A battery system, comprising:
a plurality of battery cells electrically connected to each other;
a plurality of switches each connected to one of the battery cells;
one or more heaters electrically connected to the switches and configured to dissipate power from the battery cells; and
one or more heat conduits to channel the heat generated by the one or more heaters towards at least one of the battery cells.

2. The battery system of claim 1, wherein the heat channeled by the one or more heat conduits causes the temperature of the at least one of the battery cells to reach 20-30° C.

3. The battery system of claim 1, wherein the heat conduits comprise air conduits configured to channel the heat by convection.

4. The battery system of claim 1, wherein the heat conduits comprise heat conducting pipes configured to channel the heat by conduction.

5. The battery system of claim 1, wherein the heat generated by dissipating power from the battery cells are channeled to the same battery cells dissipating the power.

6. The battery system of claim 1, wherein the heat generated by dissipating power from the battery cells are channeled to battery cells different from the battery cells dissipating the power.

7. The battery system of claim 1, further comprising a controller electrically connected to the battery cells and the switches, the controller configured to actively or passively balance a states of charge (SoC) of the battery cells using the one or more heaters.

8. The battery system of claim 1, further comprising a controller electrically connected to the battery cells and the switches, the controller configured to sense a state of charge (SoC) of each of the battery cells and to selectively activate one or more switches based on the sensed SoC.

9. The battery system of claim 8, further comprising a plurality of temperature sensors each configured to measure a temperature of at least one of the battery cells.

10. The battery system of claim 8, wherein the controller is configured to activate the one or more switches upon determining that the temperature of the at least one of the battery cells is lower than a predetermined temperature.

11. The battery system of claim 8, wherein the controller is configured to activate the one or more switches after cooling the at least one of the battery cells to a temperature lower than a predetermined temperature.

12. The battery system of claim 1, wherein each of the battery cells is a redox battery cell comprising:
a first half cell comprising a first electrolyte having dissolved therein a first redox couple configured to undergo a first redox half reaction;
a second half cell comprising a second electrolyte having dissolved therein a second redox couple configured to undergo a second redox half reaction; and
an ion exchange membrane separating the positive electrolyte reservoir and the negative electrolyte reservoir,
wherein the redox battery cells store chemical energy in the first and second electrolytes.

13. A thermal management method for a battery system, the method comprising:
detecting a state of charge (SoC) of each of a plurality of battery cells electrically connected to each other;
dissipating power from one or more of the battery cells having an SoC above a predetermined threshold value through one or more heaters to generate heat by activating one or more switches connected to the battery cells; and
channeling the heat generated from the one or more heaters through one or more heat conduits towards at least one of the battery cells.

14. The method of 13, further comprising, prior to detecting the SoC, charging or discharging the plurality of battery cells.

15. The method of 13, wherein detecting the SoC comprises measuring a cell voltage, and wherein the predetermined threshold value of the SoC corresponds to the average cell voltage.

16. The method of 13, further comprising activating a cell balancing scheme based on the detected SoC.

17. The method of 13, further comprising detecting a temperature of at least one of the battery cells prior to channeling the heat.

18. The method of 17, wherein channeling the heat comprises channeling upon detecting that the temperature of at least one of the battery cells is below a predetermined temperature.

19. The method of 17, wherein upon detecting that the temperature of at least one of the battery cells is above the predetermined temperature, the method further comprises cooling the at least one of the battery cells to a temperature below the predetermined temperature.

20. The method of 17, wherein channeling the heat comprises channeling until the temperature of the at least one of the battery cells reaches at least the predetermined temperature.

21. An energy storage system (ESS), comprising:
a battery system comprising:
a plurality of battery cells electrically connected to each other,
a plurality of switches each connected to one of the battery cells, and
one or more heaters electrically connected to the switches for actively or passively balancing states of charge (SoC) of the battery cells;
a power control system (PCS) electrically connected to the battery system; and
an electric load electrically connected to the power control unit,
wherein one or both of the PCS and the electric load are configured to be electrically connected to a grid, and
wherein one or more of the battery system, the PCS and the electric load are thermally insulated from each other by a thermal insulator.

22. An energy storage system (ESS), comprising:
a battery system comprising:
a plurality of battery cells electrically connected to each other,
a plurality of switches each connected to one of the battery cells, and
one or more heaters electrically connected to the switches for actively or passively balancing states of charge (SoC) of the battery cells;
a power control system (PCS) electrically connected to the battery system; and
an electric load electrically connected to the power control unit,
wherein one or both of the PCS and the electric load are thermally connected to the battery system by one or more heat conduits configured to channel heat generated by the one or both of the PCS and the electric load towards the at least one of the battery cells.
